(19) United States
(12) Patent Application Publication
(10) Pub. No.: US 2011/0302989 A1
(43) Pub. Date: Dec. 15, 2011

(54) Method for safe performance of a calibration and/or an adjusting of a measured variable of a measuring device in automation technology, especially in process analysis technology

(75) Inventors: Peter Biechele, Freiburg (DE); Jörg-Martin Müller, Stuttgart (DE)

(73) Assignee: Endress + Hauser Conducta Gesellschaft fur Mess- und Regeltechnik mbH + Co. KG, Gerlingen (DE)

(21) Appl. No.: 13/156,384

(22) Filed: Jun. 9, 2011

(30) Foreign Application Priority Data
Jun. 10, 2010 (DE) DE 10210029954.5

(51) Int. Cl. G01D 18/00

(52) U.S. Cl. 73/1.01

(57) ABSTRACT

A method for safe performance of a calibration and/or an adjusting of a measured variable of a measuring device in automation technology, especially in process analysis technology, in the case of which a calibration result or an adjusting value is ascertained and shown on a display. In order to assure reliable adjusting or calibrating of a measured variable of a measuring device, the calibration result or the adjusting value is shown in multiple instances at random locations of the display, wherein, upon agreement of all shown calibration results or adjusting values, a confirmation is effected by a user of the measuring device.

The invention relates to a method for safe performance of a calibration and/or an adjusting of a measured variable of a measuring device in automation technology, especially in process analysis technology, in the case of which a calibration result or an adjusting value is ascertained and shown on a display.

For performing interactive operations occurring between a user and a measuring device with the assistance of a display, it is necessary to implement safe operations. Such safe operations must conform to the standard IEC 61508. This standard concerns all safety-related systems which contain electrical, electronic or programmably electronic components, and whose failure means a significant risk for humans or the environment. Examples of such systems include automation technology measuring devices subjected to calibration or adjustment. The devices used in the system in such case, such as, for example, sensors or computing systems, are permitted according to IEC 61508. This means that measures for risk reduction were performed via defect prevention, defect detection and defect containment.

Since a sensor does not give an absolute value, the sensor and the system containing the sensor must be calibrated before being put into use. The terms “calibrating” and “calibration” refer to a measurement procedure, in which the deviation of a measured variable of a measuring device is determined with the use of a reference variable of a reference device, wherein the deviation is not only detected, but also documented. In this way, it ascertained how large the deviation between the values of the two measured variables is, or whether this deviation lies within certain limits. The measuring device so tested is then adjusted, by which is meant the exact tuning of a measured variable or the display of an instrument by intervention of a technician in the measuring system.

In the case of a calibration or adjusting of a sensor, the values of the calibration results or the adjusting values are displayed to the user with the assistance of a display. Even when the sensor has been reliably calibrated and adjusted, the display remains a safety risk, concerning whose safe functioning no statements are usually made, because the proof of functional safety according to IEC 61508 is complex, and therefore is most often avoided. Thus, one possibility is that the display has a malfunction, and the calibration results actually measured or the adjusting values actually set are thus not displayed.

An object of the invention is thus to provide a method for safe performance of calibration and/or adjusting of a measured variable of a measuring device, in the case of which errors of the display can be recognized with sufficiently high probability.

The object is achieved according to the invention by features including that the calibration result or the adjusting value is shown in multiple instances at random locations of the display, wherein, upon agreement of all shown calibration results or adjusting values, a confirmation is effected by a user of the measuring device. This has the advantage that, in the case of simultaneous display of the same calibration result or adjusting value, a malfunction of the display can safely be eliminated. Thus, it is assured that even a display which was not tested according to the standard IEC 61508 reliably gives the correct values. An erroneous display is recognized by the fact that, although the same calibration result or the same adjusting value is always input for displaying, different values are displayed at the different locations of the display.

Advantageously, the displaying of the calibration result or of the adjusting value occurs in each case at a position of the display not previously used for display. Due to such a distribution of the display values on the display, it is assured that as many positions of the display as possible are utilized for display. In this way, it is assured that, in the case of a failure of portions of the display, this would be presented optically by the distribution of the calibration result displayed in multiple instances or by the distribution of the adjusting value displayed in multiple instances.

In an embodiment, the display of the calibration result or of the adjusting value occurs in different fonts and/or font sizes. This representation is utilized when especially safety-relevant information, which should be presented on the display, is input into a measuring device.

Alternatively, in the case of especially safety-relevant information, different number systems can also be used for showing on the display. Thus, an option is to provide numbers in the hexadecimal system, in the binary system or the like.

In another variant, different ways of writing numbers can also be used, such as, for example, arabic, roman or the like. By means of such a method, the operations for displaying the calibration result or the adjusting value on the display are reliably assured. After completion of such an operation, it can be assumed therefrom that values input into the system are at all times correctly output by the measuring device.

In a further development, for calibration purposes, the measured variable of the measuring device is compared with a reference variable and the deviation of the measured variable from the reference variable is ascertained as the calibration result. After testing by the user, the result of the calibrating can be confirmed and used in the measuring device for other actions. The user will document the safely obtained result for measuring device.

Advantageously, the adjusting value is stored once in the measuring device and then is read out from the measuring device at least once, wherein the stored adjusting value and the at least one read-out adjusting value are shown on the display. On the basis of the multiple display of the adjusting value, it is decided whether the storing of the adjusting value—the so-called adjustment—has proceeded correctly, and whether the adjusting value was safely stored in the measuring device. Also in this case, the display result is confirmed by the user when both the displayed stored adjusting value as well as also the multiply read-out adjusting values deliver the same display.

In an embodiment, a result produced in a preceding process, especially the calibration result, is utilized as an adjusting value. Since the adjusting always builds on a previously run process, the adjusting procedure selected thusly is applicable in a versatile manner.

Additionally, the display of the calibration result or of the adjusting value is produced on an on-site display, especially at the location of use of the measuring device. Such an on-site display does not involve a safe display, which means that this display was not subjected to any test routines for establishing its safe functional ability. The method of the invention thus especially permits calibration or adjustment procedures with the assistance of such non-safe displays.

In an especially simple embodiment, the confirmation of the calibration result or of the adjusting value is effected by the user by touching a button embodied as a soft key, whereas especially touching any other buttons embodied as soft keys on the display leads to a rejection of the calibration result or of the adjusting value. Through the embodiment of the display as a touch screen, additional hardware means can be omitted, whereby an especially cost-effective variant is enabled. Since especially pressing any other keys leads to a rejecting of the results, via this procedure, assurance against an erroneous acceptance of incorrect results by the user is significantly increased.

The invention allows for numerous forms of embodiment. One of these will now be explained in greater detail on the basis of the appended drawing, the figures of which show as follows:

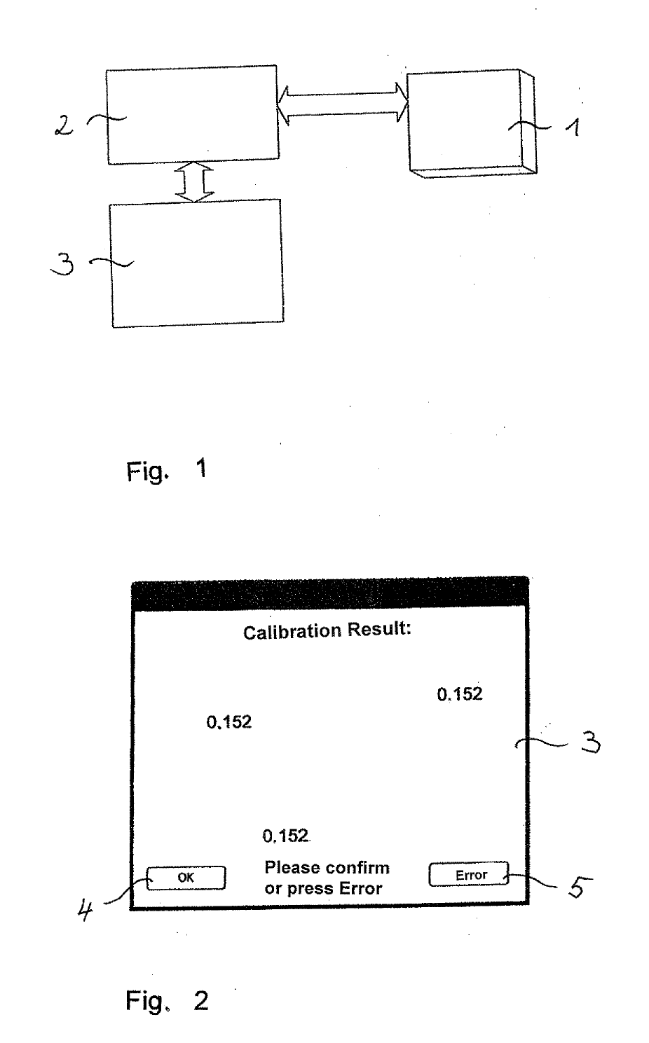

FIG. 1 schematic representation of a system, which is to be calibrated or adjusted.

FIG. 2 example of multiple display of a calibration result according to the method of the invention.

FIG. 1 shows configuration of a system containing a sensor 1 permitted according to IEC 61508, wherein the sensor communicates with a transmitter 2, wherein the transmitter 2 is likewise permitted according to IEC 61508. The transmitter 2 is connected with an untested (and, as a result, non-safe) display 3, which is embodied as a touch screen. Such systems are utilized in process analysis technology, for example, for measuring and displaying a pH-value. The sensor 1 includes, in such case, an evaluating electronics (not shown explicitly), which includes a memory for required adjusting or calibration data.

In a first sequence, the system of FIG. 1 is calibrated. In such case, in a first step, the measurement signal delivered by the sensor 1 is compared with a reference value. In the case of a difference between the measurement signal and the reference value, a difference value is ascertained. The difference value is determined as the calibration result and forwarded to the transmitter 2. The transmitter 2 forwards the calibration value to the display 3, which, as shown in FIG. 2, shows the calibration result in multiple instances at random locations of the display. In the present case, 0.152 is the calibration result. In driving the display, it is assured that each calibration value is presented at a different position of the display 3. As a result, the indicated calibration results are not allowed to overlap in the presentation on the display 3. A user monitoring the calibration evaluates the results shown on the display 3. In the case of an agreement of all displayed calibration values, i.e. all display values show 0.152, an OK button 4 on the display 3 is actuated by the user.

Contrary to the situation shown in FIG. 2, should the calibration results displayed on the display 3 not agree, a defect button 5 on the display 3 is pressed by the user. If the test was positive, the user then logs that the calibrating of the sensor 1 has occurred reliably.

In the case of especially safety-relevant information, the showing on the display can be improved by other measures, such as, for example, representation with the assistance of different fonts, other number systems or different ways of writing numbers. After the testing by the user, the confirmed calibration result is stored in the sensor 1, and is used for other actions.

In a second sequence, which follows the calibrating, an adjusting is performed with the same non-safe display 3. The calibration result which was ascertained and confirmed by the user in sequence 1 is taken in such case as an adjusting value. In a next step, this calibration result, which now is utilized as an adjusting value, is stored in the sensor 1, wherein the sensor 1 represents only one measuring point in a network of measuring points in process analysis technology. There, the adjusting value is further used for future calculations, which are possibly part of a safety function. In such case, it must be taken into consideration that the adjusting value is stored only once in the sensor 1. Then, the adjusting value is read-out from the sensor 1 multiple times. The adjusting value, which is stored once, and the plurality of read-out adjusting values are now displayed in the display 3, which, again, is a non-safe display. This displaying, in turn, occurs for the individual adjusting values at random locations of the display 3. Based on the multiple displayings, the user will decide whether the storing—whereby in this connection the adjusting is meant—has proceeded correctly, and whether the adjusting value was safely stored in the sensor 1. This is the case when the displayed stored adjusting value and the read-out adjusting values agree.

The interactions with the user occur, in such case, via so-called soft keys. Here, particular meanings are assigned via software, depending on user context, to the permanently installed keys. These meaning are presented on the display. If the confirmation of the calibration result or of the adjusting value is effected via such soft keys, then, in the case of a plurality of soft keys being present (in this case, keys 4 and 5), a key whose being pressed effects a positive confirmation of the results is randomly selected by the software. The pressing of all other keys leads to a rejection of the results. This procedure significantly increases safety against an erroneous acceptance of non-correct results by the user.

Due to the multiple, random display of a value on a non-safe display for confirmation by a user, errors in the interactive operations between the display and user, as regards calibration or adjusting in automation technology, are recognized with high probability,. Especially in the case of the adjusting, the storing of the adjusting value in the measuring device and the subsequent multiple reading-out of the adjusting value are utilized in order to detect whether the adjusting value was actually stored safely in the sensor 1. In the case of this procedure, confirmation by the user is absolutely necessary.

1. Method for safe performance of a calibration and/or an adjusting of a measured variable of a measuring device in automation technology, especially process analysis technology, in the case of which a calibration result or an adjusting value is ascertained and shown on a display (3), characterized in that the calibration result or the adjusting value is shown in multiple instances at random locations of the display (3), wherein, upon agreement of all shown calibration results or adjusting values, a confirmation is effected by a user of the measuring device (1).

2. Method as claimed in claim 1, characterized in that display of the calibration result or adjusting value occurs in each case at a position of the display (3) not previously used for display.

3. Method as claimed in claim 1 or 2, characterized in that display of the calibration result or adjusting value occurs in different fonts and/or font sizes.

4. Method as claimed in claim 1, 2 or 3, characterized in that display of the calibration result or adjusting value occurs in different number systems.

5. Method as claimed in at least one of the preceding claims, characterized in that display of the calibration result or adjusting value occurs in different ways of writing numbers.

6. Method as claimed in at least one of the preceding claims, characterized in that for calibration purposes, the measured variable of the measuring device (1) is compared with a reference variable, and a deviation of the measured variable from the reference variable is ascertained as calibration result.

7. Method as claimed in at least one of claims 1 to 5, characterized in that the adjusting value is stored once in the measuring device (1) and then is read-out from the measuring device (1) at least once, wherein the stored adjusting value and the at least one read-out adjusting value are displayed on the display (3).

8. Method as claimed in claim 7, characterized in that a result of a preceding process, especially the calibration result, is used as an adjusting value.

9. Method as claimed in at least one of the preceding claims, characterized in that display of the calibration result or adjusting value occurs on an on-site display (3), especially at a location of use of the measuring device (1).

10. Method as claimed in at least one of the preceding claims, characterized in that the confirmation of the calibration result or of the adjusting value is effected by the user by touching a button embodied as a soft key (4), whereas especially touching any additional button embodied as a soft key (5) on the display (3) leads to a rejection of the calibration result or of the adjusting value.
